(19) United States
(12) Patent Application Publication
(10) Pub. No.: US 2013/0083826 A1
(43) Pub. Date: Apr. 4, 2013

(54) SPREADING DATA SYMBOLS AMONG MULTIPLE LAYERS IN A MIMO TRANSMISSION SCHEME

(71) Applicant: Chenxi Zhu, Fairfax, VA (US)

(72) Inventor: Chenxi Zhu, Fairfax, VA (US)

(73) Assignee: Fujitsu Limited, Kanagawa (JP)

(21) Appl. No.: 13/489,230

(22) Filed: Jun. 5, 2012

Related U.S. Application Data
(60) Provisional application No. 61/541,886, filed on Sep. 30, 2011.

(51) Int. Cl. H04B 1/7097

(52) U.S. Cl. 375/144; 375/E01.02

(57) ABSTRACT

According to one embodiment, a method includes encoding a bit stream into a plurality of codewords. For each codeword of the plurality of codewords, a plurality of data symbols that represent the respective codeword are generated. Each data symbol of the respective codeword encodes one or more bits of the respective codeword into one or more modulation characteristics of a carrier wave. The method further includes spreading, by one or more processors, each data symbol of at least a subset of at least one codeword of the plurality of codewords among a plurality of layers such that each layer includes a portion of the respective data symbol. Information indicated by the plurality of layers is transmitted to an transceiver.

### RELATED APPLICATION

This application claims benefit under 35 U.S.C. §119(e) of U.S. Provisional Application Ser. No. 61/541,886, entitled “BALANCING MIMO SPATIAL STREAMS SINR FOR LTE-A DL MIMO AND COMP,” filed Sep. 30, 2011, the entire content of which is incorporated herein by reference.

### TECHNICAL FIELD

The present disclosure relates generally to methods and apparatuses for spreading data symbols among multiple layers in a multiple-input and multiple-output (MIMO) transmission scheme.

### BACKGROUND

An antenna system may include multiple transceivers such as transmission sites or endpoints. A transmission site may be a base station (also known as a Radio Element Control or a Baseband Unit) or a remote transmission site (also known as a Radio Element or a Remote Radio Head). Transmission sites provide endpoints with wireless network access. Within an antenna system, the transmission sites are distributed among different locations and are generally connected to each other via wired connections (e.g., optical fiber). An antenna system may implement a multiple-input and multiple-output (MIMO) transmission scheme where multiple transmitting antennas transmit to multiple receiving antennas. Data transmitted by the antenna system may be divided into multiple layers and/or precoded before transmission.

### SUMMARY OF THE DISCLOSURE

Various embodiments of the present disclosure relate to spreading data symbols among multiple layers in a MIMO transmission scheme. For example, in one embodiment, a method includes encoding a bit stream into a plurality of codewords. For each codeword of the plurality of codewords, a plurality of data symbols that represent the respective codeword are generated. Each data symbol of the respective codeword encodes one or more bits of the respective codeword into one or more modulation characteristics of a carrier wave. The method further includes spreading, by one or more processors, each data symbol of at least a subset of at least one codeword of the plurality of codewords among a plurality of layers such that each layer includes a portion of the respective data symbol. Information indicated by the plurality of layers is transmitted to an transceiver.

The object and advantages of the invention will be realized and achieved by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

For a more complete understanding of particular embodiments and their features and advantages, reference is now made to the following description, taken in conjunction with the accompanying drawings, in which:

FIG. 1 depicts an example antenna system that spreads data symbols among multiple layers;

FIG. 2 depicts an example method for spreading data symbols among multiple layers that may be performed by an example transceiver of the antenna system of FIG. 1;

FIG. 3 depicts an example method for decoding data symbols that have been spread among multiple layers that may be performed by an example transceiver of the antenna system of FIG. 1; and

FIG. 4 depicts example computing systems that may facilitate the operations of various components of FIG. 1.

### DETAILED DESCRIPTION OF THE DRAWINGS

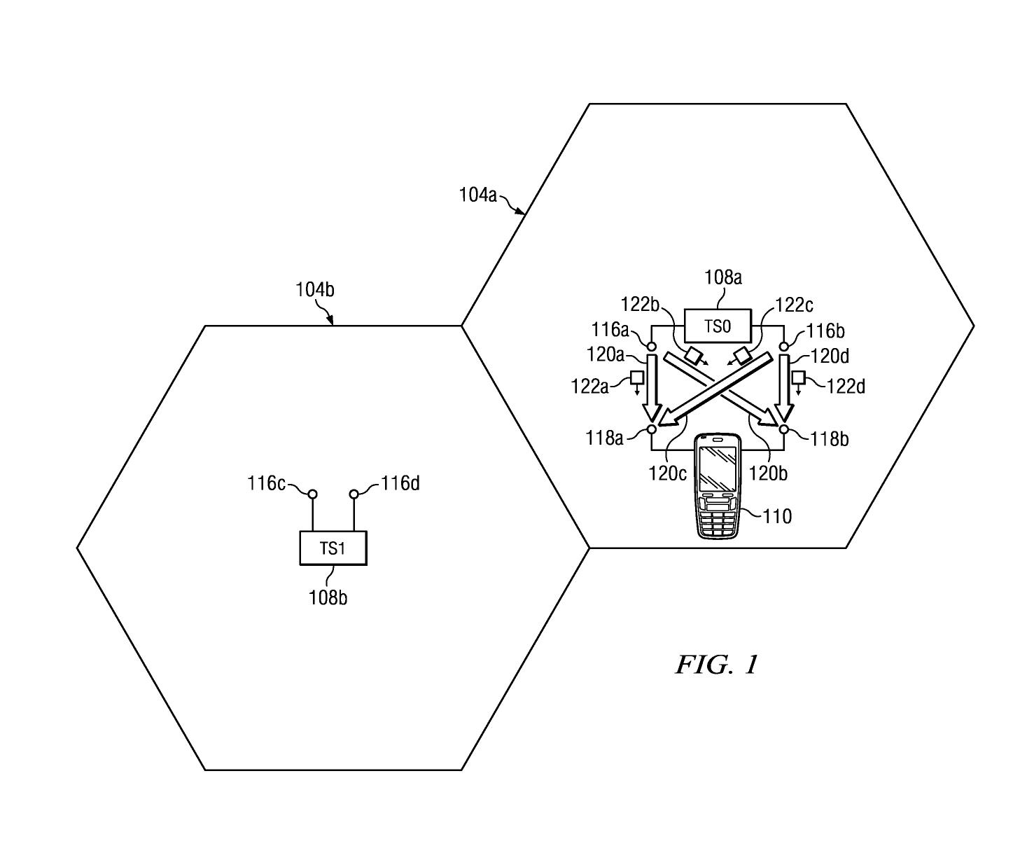

FIG. 1 depicts an example antenna system 100 that spreads data symbols among multiple layers in a multiple-input and multiple-output (MIMO) transmission scheme. Antenna system 100 includes multiple transceivers (i.e., transmission sites 108 and endpoint 110) that communicate with each other. For example, in the embodiment depicted, transmission sites 108 use antenna ports 116 to communicate with one or more endpoints 110 via antenna ports 118. Antenna system 100 provides wireless coverage for any suitable number of endpoints 110 over a geographic area, such as cell 104. For example, a transmission site 108 may be used to provide wireless coverage for an entire building, a city block, a campus, or any other area. Cell 104 may have any suitable shape, such as the honeycomb-like shape depicted in FIG. 1. One or more transmission sites 108 and an endpoint 110 may utilize a MIMO transmission scheme wherein data is communicated from multiple antenna ports 116 to multiple antenna ports 118 or from multiple antenna ports 118 to multiple antenna ports 116.

In general, a data symbol is a complex number that maps a set of bits to one or more modulation characteristics of a carrier wave. Groups of bits of a codeword to be transmitted between one or more transmission sites 108 and endpoint 110 may be encoded into data symbols that are then transmitted via carrier waves with modulated characteristics defined by the data symbols. Typical antenna systems may arrange data symbols associated with one or more codewords into multiple layers before transmission in order to improve reliability and throughput. That is, each layer may include some of the data symbols and each data symbol is assigned to a particular layer. A precoding matrix is then applied to these layers and the layers (i.e., the data symbols of the layers) are transmitted through multiple channels (i.e., paths between distinct transmitting antennas and receiving antennas) using a MIMO transmission scheme. The channels generally have different channel responses that result in differing distortion to the signals sent through each channel. Because multiple receiving antennas may detect a similar amount of noise, different gains through the channels may result in differing signal to interference plus noise (SINR) ratios among the layers. For example, one layer may have a higher SINR than another layer. Since data symbols associated with a particular codeword may be placed in different layers, the data symbols may experience different channel effects. This may result in a loss of performance, such as an increase in a bit error rate, when the codeword is decoded. In addition, the varying SINR among the layers increases the chance that one or more layers must be retransmitted even though other layers are decoded successfully, thus increasing the feedback overhead of the system.

In particular embodiments of the present disclosure, an energy spreading function may be applied to the data symbols to spread each data symbol among the layers before the layers are precoded and transmitted. Such embodiments compensate for the SINR variation among layers and balance the SINR for the data symbols of the codewords. In particular embodiments the data symbols of each individual codeword are balanced across different layers. Accordingly each received data symbol of a particular codeword will exhibit substantially the same SINR. In other particular embodiments, the data symbols of multiple codewords are balanced across multiple layers. Accordingly each data symbol of the multiple codewords will exhibit substantially the same SINR.

As used herein, “transmission site” may refer to a base station (also known as a Radio Element Control or a Baseband Unit) or a remote transmission site (also known as a Radio Element or a Remote Radio Head (RRH)). For example, transmission sites 108 may each be base stations. As another example, transmission site 108a may be a base station and transmission site 108b may be a remote transmission site. In certain situations, a transmission site 108 that is a remote transmission site may function as an extension of a transmission site 108 that is a base station. For example, the remote transmission site may send wireless signals to endpoint 110 that are similar to wireless signals that would be sent by the base station to the endpoint if endpoint 110 were located close to the base station.

Transmission site 108 may include any combination of hardware, software embedded in a computer readable medium, and/or encoded logic incorporated in hardware or otherwise stored (e.g., firmware) to implement any number of communication protocols that allow for wired or wireless exchange of information in antenna system 100. Transmission sites 108 may be operable to exchange control signals and data traffic with endpoints 110. A transmission site 108 may also be coupled to other transmission sites 108 via one or more wired connections. These wired connections may comprise any suitable material, such as optical fiber. Transmission sites 108 may use any suitable technologies or protocols (e.g., Common Public Radio Interface (CPRI)) to communicate with each other.

Transmission site 108a may communicate with endpoint 110 using wireless communication via antennas 116a and 116b. In particular embodiments, transmission site 108a coordinates with one or more other transmission sites 108 to communicate with endpoint 110. For example, transmission sites 108 may coordinate with each other to communicate with endpoint 110 using a MIMO transmission scheme where multiple transmitting antennas 116 are placed at different transmission sites 108, while one or more receiving antennas 118 are located at the endpoint 110. For example, transmission sites 108 may communicate with endpoint 110 using a downlink coordinated multi-point processing (DL CoMP) as defined in 3rd Generation Partnership Project (3GPP) Release 10 or beyond. As an example of MIMO transmission, transmission site 108a may wirelessly communicate a portion of a data stream through antennas 116a and 116b and communicate another portion of the data stream through a wired connection to one or more other transmission sites 108. The other transmission site(s) 108 then send at least a portion of the data stream to endpoint 110 via one or more wireless connections between one or more antenna ports 116 of the other transmission site(s) 108 and one or more antenna ports 118 of endpoint 110. Endpoint 110 may combine multiple signals from multiple transmission sites 108 into a single communication. Transmission sites 108 may communicate with endpoint 110 using any of a variety of different wireless technologies, including, but not limited to, orthogonal frequency division multiple access (OFDMA) and the long term evolution-advanced (LTE-A) protocol as defined in the 3GPP Release 10 or beyond.

Although not shown in the embodiment depicted, transmission sites 108 may also be coupled to any network or combination of networks capable of transmitting signals, data, and/or messages, including signals, data, or messages transmitted through WebPages, e-mail, text chat, voice over IP (VoIP), and instant messaging in order to provide services and data to endpoints 110. For example, transmission site 108a may be coupled to one or more LANs, WANs, MANs, PSTNs, WiMAX networks, global distributed networks such as the Internet, Intranet, Extranet, or any other form of wireless or wired networking. In particular embodiments, transmission site 108a also communicates with a base station controller that facilitates handoffs between cells 104 and provides other functions.

Endpoint 110 may comprise any type of wireless device able to send and receive data and/or signals to and from transmission site 108a directly and/or via one or more other transmission sites 108. Some examples of endpoints 110 include desktop computers, PDAs, cell phones, laptops, and/or VoIP phones. Endpoints 110 may provide data or network services to a user through any combination of hardware, software embedded in a computer readable medium, and/or encoded logic incorporated in hardware or otherwise stored (e.g., firmware). Endpoints 110 may also include unattended or automated systems, gateways, other intermediate components or other devices that may send or receive data and/or signals.

Various types of information may be sent to or from endpoint 110. Examples of information types include data traffic and control traffic. Data traffic is carried over a connection between one or more transmission sites 108 and endpoint 110. For example and not by way of limitation, data traffic may include information that transmission site 108 receives from a network coupled to the transmission site 108 (such as the Internet) or from another endpoint 110 located in the same cell 104 or a different cell. In a particular embodiment, data traffic is sent from one or more transmission sites 108 to endpoint 110 via a physical downlink shared channel (PDSCH) as defined in the LTE-A protocol. In such embodiments, demodulation reference signals (DM-RS) as defined in the LTE-A protocol may be sent from the physical antenna ports 116 of the transmission sites 108 and used to extract the relevant data traffic from the PDSCH. In a particular embodiment, data traffic is sent from an endpoint 110 to one or more transmission sites 108 via a Physical Uplink Shared Channel (PUSCH) as defined in the LTE-A protocol.

Control traffic sent between one or more transmission sites 108 and endpoint 110 may be used to setup and maintain a connection between the one or more transmission sites 108 and endpoint 110. In particular embodiments, control traffic is transmitted by a single transmission site 108 or jointly by multiple transmission sites 108. The control traffic may include information (e.g., scheduling or demodulation information) that allows endpoint 110 to extract relevant data traffic from transmissions sent from the transmission sites 108. In particular embodiments, control traffic conforms to the LTE-A standard. For example, control traffic may include cell-specific reference signals (CRS) such as primary synchronization signal (PSS), secondary synchronization signal (SSS), physical broadcast channel (PBCH), and/or physical downlink control channel (PDCCH) reference signals. Endpoint 110 may send similar control traffic to one or more transmission sites 108.

When wireless signals are sent from transmission site 108 to endpoint 110, they may take many directions (resulting in multipath fading) and may be reflected (e.g., by buildings or cars) or obstructed by objects such as trees. A channel 120 is a composite representation of the various paths taken by wireless signals communicated between a particular antenna 116 of a transmission site 108 and a particular antenna 118 of endpoint 110. For example, channel 120a represents the paths of wireless signals sent from antenna 116a to antenna 118a. Each channel 120 may have a unique frequency response. Accordingly, data passed through different channels may be affected in different ways (for example, if the same data symbol is sent through two different channels 120, endpoint 110 may detect two different received data symbols due to the different frequency responses of the channels 120). As explained above, the varying characteristics of the channels may result in detrimental effects to the decoding of codewords at the receiving transceiver when data symbols of the codewords are transmitted in multiple layers using a MIMO scheme. In particular embodiments, these effects may be reduced or eliminated by spreading each data symbol of a plurality of data symbols across multiple layers before transmission.

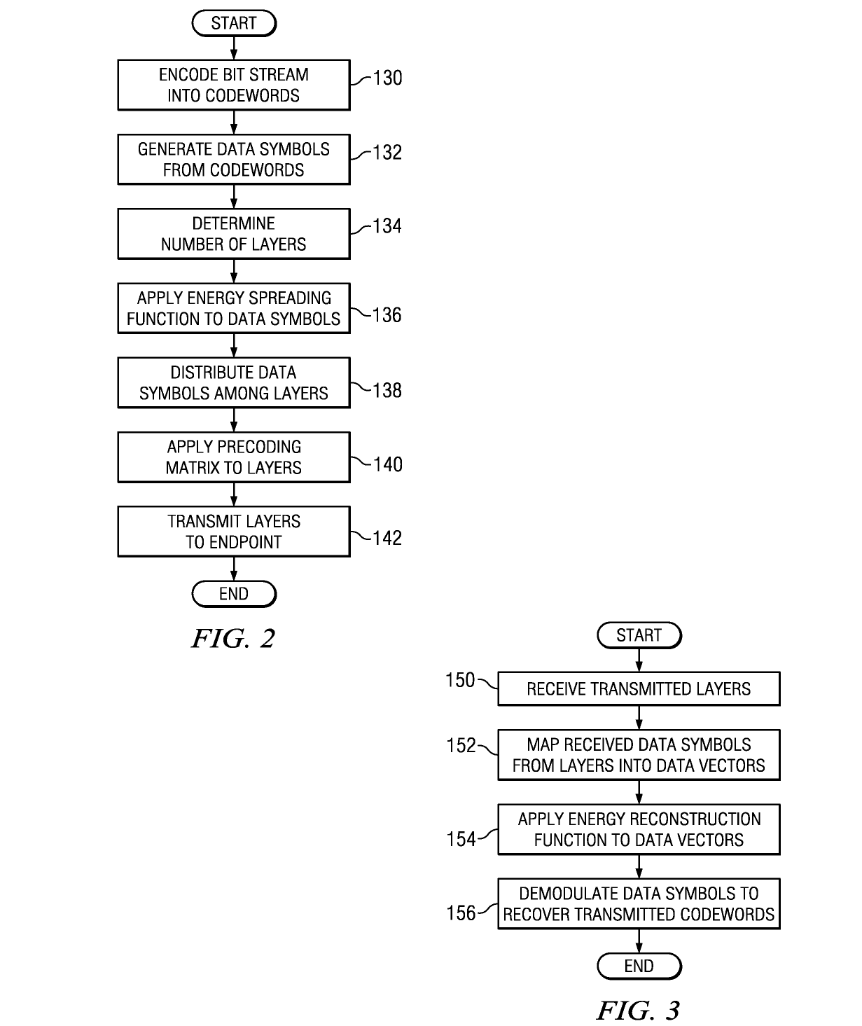

FIG. 2 depicts an example method for spreading data symbols among multiple layers that may be performed by a transceiver of antenna system 100. For purposes of simplicity, the illustrated steps of the method of FIG. 2 are described from the perspective of a transmission site 108 though they could alternatively be performed by an endpoint 110. The method begins at step 130 where a bit stream is encoded into codewords. A bit stream is a series of bits that are communicated between one or more transmission sites 108 and endpoint 110. In particular embodiments, the bit stream carries the information of the data traffic described above. The bit stream may be broken up into blocks and then encoded to form codewords. For example, the encoding may include inserting redundant data into the blocks to increase the probability that the data of the blocks will be properly detected when received at the receiving transceiver. In a particular embodiment, forward error correction techniques, such as turbo coding are applied to the blocks to form the codewords.

At step 132, data symbols are generated from the codewords. A data symbol is a complex number with real and/or imaginary components that map a group of bits to one or more modulation characteristics of a carrier wave. Groups of bits of a codeword may be encoded into data symbols associated with the codeword. The data symbols may be transmitted (generally after one or more processing steps) to the endpoint 110 via carrier waves with modulated characteristics defined by the data symbols (or the data symbols that result from the processing of the original data symbols). As an example, a data symbol may define a phase modulation and/or an amplitude modulation of a carrier wave. The modulation characteristics defined by the data symbol are determined by the bits of the codewords. For a particular codeword, groups of bits of the codeword are modulated to form the data symbols. Particular embodiments may use quadrature phase-shift keying (QPSK), quadrature amplitude modulation (QAM)16, or QAM64 modulation to generate data symbols from the bits of the codewords. For example, each two bit pair of a codeword may be modulated to form each data symbol if QPSK is used or each four bit group of a codeword may be modulated to form each data symbol if QAM16 is used.

After the bits of the codewords have been modulated into data symbols, the number of layers may be determined at step 134. In general, the number of layers is less than or equal to the number of antennas 116 that will be used to transmit the data symbols associated with the codewords. Each layer includes a plurality of data symbols that will be transmitted by a plurality of antennas 116. In particular embodiments, each layer includes the same number of data symbols associated with a particular codeword or substantially the same number of data symbols (e.g., a layer may have one more data symbol than another layer) and a particular data symbol is placed into a single layer. In particular embodiments, the data symbols of the layers may undergo signal processing before being transmitted.

At step 136, an energy spreading function is applied to the data symbols formed from the bits of the codewords. The energy spreading function operates to spread each data symbol over multiple layers. That is, for a particular data symbol, each of the layers may carry a portion of the data symbol. In a particular embodiment, an energy spreading function is applied to a group of data symbols to smear each data symbol among itself and the other data symbols. Accordingly, after the energy spreading function is applied, each data symbol of the group may include a portion of each of the original data symbols of the group. Each smeared data symbol of the group may then be placed into a distinct layer, thereby spreading each original data symbol of the group among multiple layers. In another particular embodiment, the data symbols may be placed into layers first and then an energy spreading function applied to the multiple layers to smear the data symbols among the multiple layers.

In a particular embodiment, data symbols associated with an individual codeword are spread across different layers separately from data symbols associated with another codeword that is spread across the different layers. This may be accomplished in any suitable manner. In the following example, v represents the number of layers into which the data symbols are distributed. In order to spread the data symbols associated with a codeword among multiple layers, an energy spreading function may manipulate v consecutive data symbols of the codeword. These v consecutive data symbols form a vector D. In particular embodiments, applying the energy spreading function includes multiplying D by a unitary matrix of size v. A unitary matrix is a complex matrix U satisfying the condition U^{†}U=UU^{†}=Iᵥ, where Iᵥ is the identity matrix in v dimensions and U^{†} is the conjugate transpose (also called the Hermitian adjoint) of U. Any suitable unitary matrix may be multiplied with D. In particular embodiments, the unitary matrix is a discrete Fourier transform (DFT) or an inverse DFT (IDFT) of size v. The application of the energy spreading function to vector D will result in the generation of a new vector E that includes a plurality of data symbols that each include a portion of the original data symbols of the vector D. As an example, when a DFT is used, the following equation represents the result of the application of the energy spreading function: E=DFTᵥ·D. The application of the energy spreading function may be repeated for each v consecutive data symbols of the individual codeword to generate multiple vectors E. When placed together these vectors may form a vector E⁽⁰⁾ that includes data symbols representing the particular codeword (e.g., codeword 0). This same process may be followed for any number of codewords. Because the data symbols have been spread among each other, when they are later distributed into multiple layers, the data symbols will be spread among the layers. Spreading the symbols of an individual codeword among multiple layers may result in balancing the SINR among each symbol of the codeword.

In another particular embodiment, data symbols associated with multiple different codewords are spread together across different layers. This may be accomplished in any suitable manner. In the following example, c represents the number of codewords distributed among v layers. In order to spread the data symbols of multiple codewords among multiple layers, the energy spreading function may manipulate a matrix including data symbols associated with each of the c codewords. This manipulation may include multiplying the matrix by a unitary matrix of size v to spread each data symbol of the matrix among itself and the other data symbols of the matrix. Any suitable unitary matrix may be used. In particular embodiments, the unitary matrix is a discrete Fourier transform (DFT) or an inverse DFT (IDFT). As an example, if c=2 and v=2 the following equation may represent the application of the energy spreading function to data symbols associated with multiple codewords:

$$[ \begin{matrix}{e}^{( 0 )} ( i ) \\ {e}^{( 1 )} ( i )\end{matrix} ] = \frac{1}{\sqrt{2}} [ \begin{matrix}1 & 1 \\ 1 & - 1\end{matrix} ] [ \begin{matrix}{d}^{( 0 )} ( i ) \\ {d}^{( 1 )} ( i )\end{matrix} ]$$

In this equation, d⁽⁰⁾(i) represents c data symbols of codeword 0 (d⁽⁰⁾) and d⁽¹⁾(i) represents c data symbols of codeword 1 (d⁽¹⁾). The matrix composed of d⁽⁰⁾(i) and d⁽¹⁾(i) is multiplied by a DFT of size v=2 to produce e⁽⁰⁾(i) and e⁽¹⁾(i) which each include c data symbols. The data symbols of e⁽⁰⁾(i) and e⁽¹⁾(i) each include portions of each of the original data symbols of d⁽⁰⁾(i) and d⁽¹⁾(i). The application of the energy spreading function may be repeated for additional data symbols of the codewords to form vectors e⁽⁰⁾ and e⁽¹⁾ that include data symbols that represent all of the data symbols of codeword 0 and codeword 1. Because the data symbols have been spread among each other, when they are later distributed into multiple layers, the data symbols will be spread among the layers. Spreading the symbols from multiple codewords among multiple layers may result in balancing the SINR among all of the symbols of all of the codewords.

At step 138, the data symbols are distributed among the multiple layers. In particular embodiments, each data symbol is placed into one layer and thus each layer includes some of the data symbols. As examples of distributing the data symbols, the data symbols of the vectors E⁽⁰⁾ or e⁽⁰⁾ and e⁽¹⁾ may be distributed among the v layers. Thus, data symbols that have already been spread among each other may be distributed among multiple layers. As another example, data symbols that have not been spread among each other may be distributed among multiple layers and then an energy spreading function may be applied to the multiple layers. The distribution of data symbols into multiple layers may be done in any suitable manner. For example, for vector e⁽⁰⁾, the following distribution algorithm may be used: x^{(k)}(i)=e⁽⁰⁾(vi+k) for k=0, . . . , v−1 and where x^{(k)} is a vector representing the kth layer.

At step 140, one or more precoding matrices are applied to the data symbols of the layers. A precoding matrix may be used to compensate for the various frequency responses of one or more channels 120. The one or more precoding matrices may be determined in any suitable manner. For example, in particular embodiments, one or more reference signals are sent to the endpoint 110 from a transmission site 108 and the endpoint 110 selects the one or more precoding matrices from a codebook based on the frequency response of one or more channels 120 between the transmission site 108 and the endpoint 110. The application of a precoding matrix to the data symbols of the layers may distribute the layers among multiple antennas 116. For example, applying the precoding matrix to multiple layers of data symbols may result in the creation of a vector for each antenna 116 of one or more transmission sites 108 where each vector includes data symbols to be transmitted by the particular antenna 116. These data symbols may be modified versions of the data symbols placed into the layers at step 138. For example, the precoding matrix may divide portions of a particular data symbol of a particular layer among multiple transmitting antennas. Thus, in particular embodiments, a data symbol of a particular layer may be split up and transmitted by multiple antennas 116.

At step 142, the data symbols of the data layers are transmitted by antennas 116 of one or more transmission sites 108 to the antennas 118 of endpoint 110. In particular embodiments, the data symbols may undergo further processing before being transmitted by antennas 116. Regardless of the type of processing that occurs, the information encoded in the data symbols of the layers is transmitted by transmission sites 108 and detected by endpoint 110. In particular embodiments, transmission sites 108 may transmit a plurality of wireless signals 122 that include modulated carrier waves that carry the information encoded in the data symbols of the layers.

Some of the steps illustrated in FIG. 2 may be combined, modified or deleted where appropriate, and additional steps may also be added to the flowchart. Additionally, steps may be performed in any suitable order without departing from the scope of particular embodiments. Although, the steps of FIG. 2 have been described with respect to a transmission site 108, they may be performed by any suitable transceiver, such as endpoint 110.

FIG. 3 depicts an example method for decoding data symbols that have been spread among multiple layers that may be performed by a transceiver of antenna system 100. For purposes of simplicity, the illustrated steps of the method of FIG. 3 are described from the perspective of an endpoint 110 though they could also be performed by one or more transmission sites 108. The method begins at step 150 where a plurality of transmitted layers are received. For example, endpoint 110 may receive modulated carrier waves from multiple transmitting antennas 116. In particular embodiments, endpoint 110 may combine signals received from multiple transmission antennas 116 and/or apply a filter to the received signals (e.g., a zero forcing or minimum mean-squared error receiver filter) and then map the signals to data symbols. Endpoint 110 may map the received signals to data symbols in any suitable manner.

At step 152, the detected data symbols are mapped into data vectors. In particular embodiments, endpoint 110 may process the detected data symbols in any suitable manner before mapping the data symbols into data vectors. In a particular embodiment, vectors corresponding to the vectors that were mapped into layers in the examples above may be formed. As an example, if data symbols associated with a particular codeword were spread among each other and then distributed to multiple layers at the transmission site 108, data vectors Ê corresponding to the vectors E described above (i.e., the Ê vectors are the received versions of the E vectors) may be constructed. As another example, if data symbols associated with two codewords were spread among each other and then distributed to multiple layers at the transmission site 108, data vectors ê⁽⁰⁾ and ê⁽¹⁾ that correspond to e⁽⁰⁾ and e⁽¹⁾ as described above (i.e., ê⁽⁰⁾ and ê⁽¹⁾ are the received versions of e⁽⁰⁾ and e⁽¹⁾) may be constructed at endpoint 110. In other embodiments, any suitable number of vectors may be formed for any suitable number of codewords that were associated with data symbols spread together at the transmitter.

At step 154, an energy reconstruction function is applied to the constructed data vectors. In particular embodiments, the energy reconstruction function is the inverse of the energy spreading function applied at transmission site 108. For example, in particular embodiments, the application of the energy reconstruction function includes multiplying data symbols of the one or more constructed vectors at the endpoint 110 by the conjugate transpose of a unitary matrix applied to corresponding data symbols at transmission site 108. As an example, for a constructed vector Ê, the energy spreading function applied at transmission site 108 to generate the corresponding vector E may have included multiplying v consecutive symbols D associated with a codeword by a DFT matrix of size v. Accordingly, the energy reconstruction function may be expressed as \hat{D}=IDFTᵥ·Ê, where \hat{D} corresponds to D as described above. As another example, if vectors such as ê⁽⁰⁾ and ê⁽¹⁾ that each include portions of multiple codewords are constructed and a DFT of size v=2 was applied as the energy spreading function, then an IDFT of size v=2 may be used as the energy reconstruction function as follows:

$$[ \begin{matrix}{\hat{d}}^{( 0 )} ( i ) \\ {\hat{d}}^{( 1 )} ( i )\end{matrix} ] = \frac{1}{\sqrt{2}} [ \begin{matrix}1 & 1 \\ 1 & - 1\end{matrix} ] [ \begin{matrix}{\hat{e}}^{( 0 )} ( i ) \\ {\hat{e}}^{( 1 )} ( i )\end{matrix} ]$$

In this equation, \hat{d}⁽⁰⁾(i) and \hat{d}⁽¹⁾(i) correspond to d⁽⁰⁾(i) and d⁽¹⁾(i) as described above. Although various examples have been given wherein the energy reconstruction function is an IDFT, in other embodiments, the energy reconstruction function may any suitable function that allows recovery of the data at the receiver. For example, the energy reconstruction function may be a unitary matrix such as a Hermitian adjoint of a unitary matrix applied to spread the data symbols at the transmitting side. After the energy reconstruction function has been applied, if there are no receiving errors, the resulting data vectors will include the same data symbols as the original data symbols generated from the codewords (before the data symbols were mapped into layers and/or spread among other data symbols) that encoded the bit stream at transmission site 108.

At step 156, the data symbols are demodulated to recover the codewords. That is, the data symbols may be mapped to a group of bits of the codewords. After the data symbols have been demodulated, the bits may be decoded to recover the original bit stream.

Some of the steps illustrated in FIG. 3 may be combined, modified or deleted where appropriate, and additional steps may also be added to the flowchart. Additionally, steps may be performed in any suitable order without departing from the scope of particular embodiments. Although, the steps of FIG. 3 have been described with respect to a endpoint 110, they may be performed by any suitable transceiver, such as a transmission site 108.

Although certain steps are described above as being performed by certain components, in general, the steps may be performed by any suitable components. Although FIG. 1 illustrates a particular number and configuration of cells 104, endpoints 110, transmission sites 108, channels 120, and antennas 116 and 118, antenna system 100 contemplates any number or arrangement of such components for communicating data. In addition, elements of antenna system 100 may include components centrally located (local) with respect to one another or distributed throughout antenna system 100.

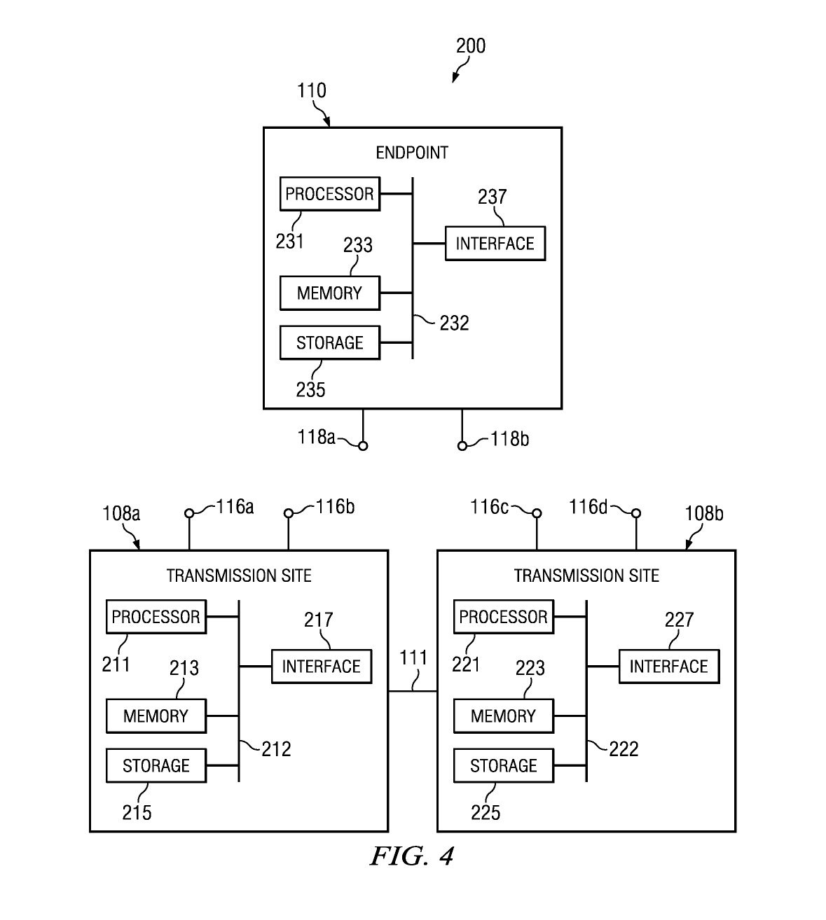

FIG. 4 depicts example computing systems that may facilitate the operations of various components of FIG. 1. FIG. 4 includes an example antenna system 200 with two example transmission sites 108 and an example endpoint 110. Antenna system 200 may correspond to at least a portion of antenna system 100 of FIG. 1. Transmission sites 108 and endpoint 110 may each include one or more portions of one or more computer systems. In particular embodiments, one or more of these computer systems may perform one or more steps of one or more methods described or illustrated herein. In particular embodiments, one or more computer systems may provide functionality described or illustrated herein. In particular embodiments, encoded software running on one or more computer systems may perform one or more steps of one or more methods described or illustrated herein or provide functionality described or illustrated herein.

The components of a transmission site 108 and an endpoint 110 may comprise any suitable physical form, configuration, number, type and/or layout. As an example, and not by way of limitation, transmission site 108 and/or endpoint 110 may comprise an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, transmission site 108 and/or endpoint 110 may include one or more computer systems; be unitary or distributed; span multiple locations; span multiple machines; or reside in a cloud, which may include one or more cloud components in one or more networks.

In the depicted embodiment, transmission sites 108 and endpoint 110 each include their own respective processors 211, 221, and 231; memory 213, 223, and 233; storage 215, 225, and 235; interfaces 217, 227, and 237; and buses 212, 222, and 232. Although a particular antenna system is depicted having a particular number of particular components in a particular arrangement, this disclosure contemplates any suitable antenna system 200 having any suitable number of any suitable components in any suitable arrangement. For simplicity, similar components of transmission sites 108 and endpoint 110 will be discussed together while referring to the component of transmission site 108. However, it is not necessary for these devices to have the same components, or the same type of components. For example, processor 211 may be a general purpose microprocessor and processor 231 may be an application specific integrated circuit (ASIC).

Processor 211 may be a microprocessor, controller, or any other suitable computing device, resource, or combination of hardware, software and/or encoded logic operable to provide, either alone or in conjunction with other components, (e.g., memory 213) wireless networking functionality. Such functionality may include providing various wireless features discussed herein. Additional examples and functionality provided, at least in part, by processor 211 will be discussed below.

In particular embodiments, processor 211 may include hardware for executing instructions, such as those making up a computer program. As an example and not by way of limitation, to execute instructions, processor 211 may retrieve (or fetch) instructions from an internal register, an internal cache, memory 213, or storage 215; decode and execute them; and then write one or more results to an internal register, an internal cache, memory 213, or storage 215.

In particular embodiments, processor 211 may include one or more internal caches for data, instructions, or addresses. This disclosure contemplates processor 211 including any suitable number of any suitable internal caches, where appropriate. As an example and not by way of limitation, processor 211 may include one or more instruction caches, one or more data caches, and one or more translation lookaside buffers (TLBs). Instructions in the instruction caches may be copies of instructions in memory 213 or storage 215 and the instruction caches may speed up retrieval of those instructions by processor 211. Data in the data caches may be copies of data in memory 213 or storage 215 for instructions executing at processor 211 to operate on; the results of previous instructions executed at processor 211 for access by subsequent instructions executing at processor 211, or for writing to memory 213, or storage 215; or other suitable data. The data caches may speed up read or write operations by processor 211. The TLBs may speed up virtual-address translations for processor 211. In particular embodiments, processor 211 may include one or more internal registers for data, instructions, or addresses. Depending on the embodiment, processor 211 may include any suitable number of any suitable internal registers, where appropriate. Where appropriate, processor 211 may include one or more arithmetic logic units (ALUs); be a multi-core processor; include one or more processors 211; or any other suitable processor.

Memory 213 may be any form of volatile or non-volatile memory including, without limitation, magnetic media, optical media, random access memory (RAM), read-only memory (ROM), flash memory, removable media, or any other suitable local or remote memory component or components. In particular embodiments, memory 213 may include random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM, or any other suitable type of RAM or memory. Memory 213 may include one or more memories 213, where appropriate. Memory 213 may store any suitable data or information utilized by transmission site 108, including software embedded in a computer readable medium, and/or encoded logic incorporated in hardware or otherwise stored (e.g., firmware). In particular embodiments, memory 213 may include main memory for storing instructions for processor 211 to execute or data for processor 211 to operate on. In particular embodiments, one or more memory management units (MMUs) may reside between processor 211 and memory 213 and facilitate accesses to memory 213 requested by processor 211.

As an example and not by way of limitation, transmission site 108 may load instructions from storage 215 or another source (such as, for example, another computer system, another base station, or a remote transmission site) to memory 213. Processor 211 may then load the instructions from memory 213 to an internal register or internal cache. To execute the instructions, processor 211 may retrieve the instructions from the internal register or internal cache and decode them. During or after execution of the instructions, processor 211 may write one or more results (which may be intermediate or final results) to the internal register or internal cache. Processor 211 may then write one or more of those results to memory 213. In particular embodiments, processor 211 may execute only instructions in one or more internal registers or internal caches or in memory 213 (as opposed to storage 215 or elsewhere) and may operate only on data in one or more internal registers or internal caches or in memory 213 (as opposed to storage 215 or elsewhere).

In particular embodiments, storage 215 may include mass storage for data or instructions. As an example and not by way of limitation, storage 215 may include a hard disk drive (HDD), a floppy disk drive, flash memory, an optical disc, a magneto-optical disc, magnetic tape, or a Universal Serial Bus (USB) drive or a combination of two or more of these. Storage 215 may include removable or non-removable (or fixed) media, where appropriate. Storage 215 may be internal or external to transmission site 108, where appropriate. In particular embodiments, storage 215 may be non-volatile, solid-state memory. In particular embodiments, storage 215 may include read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. Storage 215 may take any suitable physical form and may comprise any suitable number or type of storage. Storage 215 may include one or more storage control units facilitating communication between processor 211 and storage 215, where appropriate.

In particular embodiments, interface 217 may include hardware, encoded software, or both providing one or more interfaces for communication (such as, for example, packet-based communication) between transmission sites 108, endpoints 110, any networks, any network devices, and/or any other computer systems. As an example and not by way of limitation, communication interface 217 may include a network interface controller (NIC) or network adapter for communicating with an Ethernet or other wire-based network and/or a wireless NIC (WNIC) or wireless adapter for communicating with a wireless network.

In some embodiments, interface 217 comprises one or more radios coupled to one or more antenna ports 116. In such an embodiment, interface 217 (and/or 227) receives digital data that is to be sent out to wireless devices, such as endpoints 110, via a wireless connection. The radio may convert the digital data into a radio signal having the appropriate center frequency, bandwidth parameters, and transmission power. Similarly, the radios may convert radio signals received via one or more receiving antennas into digital data to be processed by, for example, processor 211.

Depending on the embodiment, interface 217 may be any type of interface suitable for any type of network for which antenna system 200 is used. As an example and not by way of limitation, antenna system 200 may communicate with an ad-hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, antenna system 200 may communicate with a wireless PAN (WPAN) (such as, for example, a BLUETOOTH WPAN), a WI-FI network, a WI-MAX network, an LTE network, an LTE-A network, a cellular telephone network (such as, for example, a Global System for Mobile Communications (GSM) network), or any other suitable wireless network or a combination of two or more of these. Transmission site 108 may include any suitable interface 217 for any one or more of these networks, where appropriate.

In some embodiments, interface 217 may include one or more interfaces for one or more I/O devices. One or more of these I/O devices may enable communication between a person and transmission site 108. As an example and not by way of limitation, an I/O device may include a keyboard, keypad, microphone, monitor, mouse, printer, scanner, speaker, still camera, stylus, tablet, touchscreen, trackball, video camera, another suitable I/O device or a combination of two or more of these. An I/O device may include one or more sensors. Particular embodiments may include any suitable type and/or number of I/O devices and any suitable type and/or number of interfaces 117 for them. Where appropriate, interface 117 may include one or more drivers enabling processor 211 to drive one or more of these I/O devices. Interface 117 may include one or more interfaces 117, where appropriate.

Bus 212 may include any combination of hardware, software embedded in a computer readable medium, and/or encoded logic incorporated in hardware or otherwise stored (e.g., firmware) to couple components of transmission site 108 to each other. As an example and not by way of limitation, bus 212 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or any other suitable bus or a combination of two or more of these. Bus 212 may include any number, type, and/or configuration of buses 212, where appropriate. In particular embodiments, one or more buses 212 (which may each include an address bus and a data bus) may couple processor 211 to memory 213. Bus 212 may include one or more memory buses.

Herein, reference to a computer-readable storage medium encompasses one or more tangible computer-readable storage media possessing structures. As an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, a flash memory card, a flash memory drive, or any other suitable tangible computer-readable storage medium or a combination of two or more of these, where appropriate.

Particular embodiments may include one or more computer-readable storage media implementing any suitable storage. In particular embodiments, a computer-readable storage medium implements one or more portions of processor 211 (such as, for example, one or more internal registers or caches), one or more portions of memory 213, one or more portions of storage 215, or a combination of these, where appropriate. In particular embodiments, a computer-readable storage medium implements RAM or ROM. In particular embodiments, a computer-readable storage medium implements volatile or persistent memory. In particular embodiments, one or more computer-readable storage media embody encoded software.

Herein, reference to encoded software may encompass one or more applications, bytecode, one or more computer programs, one or more executables, one or more instructions, logic, machine code, one or more scripts, or source code, and vice versa, where appropriate, that have been stored or encoded in a computer-readable storage medium. In particular embodiments, encoded software includes one or more application programming interfaces (APIs) stored or encoded in a computer-readable storage medium. Particular embodiments may use any suitable encoded software written or otherwise expressed in any suitable programming language or combination of programming languages stored or encoded in any suitable type or number of computer-readable storage media. In particular embodiments, encoded software may be expressed as source code or object code. In particular embodiments, encoded software is expressed in a higher-level programming language, such as, for example, C, Perl, or a suitable extension thereof. In particular embodiments, encoded software is expressed in a lower-level programming language, such as assembly language (or machine code). In particular embodiments, encoded software is expressed in JAVA. In particular embodiments, encoded software is expressed in Hyper Text Markup Language (HTML), Extensible Markup Language (XML), or other suitable markup language.

Although FIGS. 1 and 4 have been described above as including particular components, the systems of FIGS. 1 and 4 may include any combination of any of the described components and any of the options or features described herein, as would be understood by one of ordinary skill in the art. For example, any of the options or features described herein may be utilized in combination with the illustrated embodiments of FIGS. 1 and 4 and/or any number of the other options or features also described herein as would be understood by one of ordinary skill in the art.

While various implementations and features are discussed with respect to multiple embodiments, it should be understood that such implementations and features may be combined in various embodiments. For example, features and functionality discussed with respect to a particular figure, such as FIG. 2, may be used in connection with features and functionality discussed with respect to another such figure, such as FIG. 1, 3, or 4, according to operational needs or desires.

Various embodiments of the present disclosure may provide one or more technical advantages. Technical advantages of particular embodiments include balancing the SINR of data symbols associated with a particular codeword. Another technical advantage may include balancing the SINR of data symbols associated with multiple different codewords. Other technical advantages may include reduced bit error rates and reduced feedback overhead due to improved data symbol detection accuracy. Other technical advantages will be readily apparent to one of ordinary skill in the art from the following figures, descriptions, and claims. Moreover, while specific advantages have been enumerated above, various embodiments may include all, some, or none of the enumerated advantages.

Although particular embodiments have been described in detail, it should be understood that various other changes, substitutions, and alterations may be made hereto without departing from the spirit and scope of particular embodiments. For example, although an embodiment has been described with reference to a number of elements included within transmission site 108 such as a processor, memory, storage, an interface, and a bus, these elements may be combined, rearranged or positioned in order to accommodate particular wireless architectures or needs. In addition, any of these elements may be provided as separate external components to transmission site 108 or each other where appropriate. Particular embodiments contemplate great flexibility in the arrangement of these elements as well as their internal components.

Numerous other changes, substitutions, variations, alterations and modifications may be ascertained by those skilled in the art and it is intended that particular embodiments encompass all such changes, substitutions, variations, alterations and modifications as falling within the spirit and scope of the appended claims.

What is claimed is:

1. A first transceiver comprising:
a processor configured to:
encode a bit stream into a plurality of codewords;
for each codeword of the plurality of codewords, generate a plurality of data symbols that represent the respective codeword, each data symbol of the respective codeword encoding one or more bits of the respective codeword into one or more modulation characteristics of a carrier wave;
spread each data symbol of at least a subset of at least one codeword of the plurality of codewords among one or more other data symbols of the subset of the at least one codeword;
distribute the spread data symbols among a plurality of layers; and
apply one or more precoding matrices to the spread data symbols of the plurality of layers; and
an interface coupled to the processor and configured to transmit information indicated by the plurality of layers to a second transceiver.

2. A first transceiver comprising:
a processor configured to:
encode a bit stream into a plurality of codewords;
for each codeword of the plurality of codewords, generate a plurality of data symbols that represent the respective codeword, each data symbol of the respective codeword encoding one or more bits of the respective codeword into one or more modulation characteristics of a carrier wave;
spread each data symbol of at least a subset of at least one codeword of the plurality of codewords among a plurality of layers such that each layer includes a portion of the respective data symbol; and
an interface coupled to the processor and configured to transmit information indicated by the plurality of layers to a second transceiver.

3. The first transceiver of claim 2, wherein spreading each data symbol of the at least a subset of at least one codeword of the plurality of codewords comprises multiplying the data symbols of the at least a subset of the at least one codeword by a unitary matrix.

4. The first transceiver of claim 2, wherein spreading each data symbol of the at least a subset of at least one codeword of the plurality of codewords comprises multiplying the data symbols of the at least a subset of the at least one codeword by a discrete Fourier transform matrix or an inverse discrete Fourier transform matrix.

5. The first transceiver of claim 2, wherein spreading each data symbol of the at least a subset of at least one codeword of the plurality of codewords comprises multiplying data symbols from two or more codewords of the plurality of codewords by a unitary matrix.

6. The first transceiver of claim 2, wherein spreading each data symbol of the at least a subset of at least one codeword of the plurality of codewords comprises multiplying data symbols from two or more codewords of the plurality of codewords by a discrete Fourier transform matrix or an inverse discrete Fourier transform matrix.

7. The first transceiver of claim 2, wherein the plurality of data symbols that represent a respective codeword of the plurality of codewords are generated by quadrature phase-shift keying or quadrature amplitude modulation.

8. The first transceiver of claim 2, the processor further configured to apply a precoding matrix to the plurality of layers to assign a portion of each layer to each antenna port of a plurality of antenna ports.

9. A method comprising:
encoding, by one or more processors, a bit stream into a plurality of codewords;
for each codeword of the plurality of codewords, generating, by the one or more processors, a plurality of data symbols that represent the respective codeword, each data symbol of the respective codeword encoding one or more bits of the respective codeword into one or more modulation characteristics of a carrier wave;
spreading, by the one or more processors, each data symbol of at least a subset of at least one codeword of the plurality of codewords among a plurality of layers such that each layer includes a portion of the respective data symbol; and
transmitting information indicated by the plurality of layers to an endpoint.

10. The method of claim 9, wherein spreading each data symbol of the at least a subset of at least one codeword of the plurality of codewords comprises multiplying the data symbols of the at least a subset of the at least one codeword by a unitary matrix.

11. The method of claim 9, wherein spreading each data symbol of the at least a subset of at least one codeword of the plurality of codewords comprises multiplying the data symbols of the at least a subset of the at least one codeword by a discrete Fourier transform matrix or an inverse discrete Fourier transform matrix.

12. The method of claim 9, wherein spreading each data symbol of the at least a subset of at least one codeword of the plurality of codewords comprises multiplying data symbols from two or more codewords of the plurality of codewords by a unitary matrix.

13. The method of claim 9, wherein spreading each data symbol of the at least a subset of at least one codeword of the plurality of codewords comprises multiplying data symbols from two or more codewords of the plurality of codewords by a discrete Fourier transform matrix or an inverse discrete Fourier transform matrix.

14. The method of claim 9, wherein the plurality of data symbols that represent a respective codeword of the plurality of codewords are generated by quadrature phase-shift keying or quadrature amplitude modulation.

15. The method of claim 9, further comprising applying a precoding matrix to the plurality of layers to assign a portion of each layer to each antenna port of a plurality of antenna ports.

16. One or more non-transitory computer-readable storage media embodying logic that when executed by a processor is configured to:
encode a bit stream into a plurality of codewords;
for each codeword of the plurality of codewords, generate a plurality of data symbols that represent the respective codeword, each data symbol of the respective codeword encoding one or more bits of the respective codeword into one or more modulation characteristics of a carrier wave;
spread each data symbol of at least a subset of at least one codeword of the plurality of codewords among a plurality of layers such that each layer includes a portion of the respective data symbol; and
transmit information indicated by the plurality of layers to a transceiver.

17. The media of claim 16, wherein spreading each data symbol of the at least a subset of at least one codeword of the plurality of codewords comprises multiplying the data symbols of the at least a subset of the at least one codeword by a unitary matrix.

18. The media of claim 16, wherein spreading each data symbol of the at least a subset of at least one codeword of the plurality of codewords comprises multiplying the data symbols of the at least a subset of the at least one codeword by a discrete Fourier transform matrix or an inverse discrete Fourier transform matrix.

19. The media of claim 16, wherein spreading each data symbol of the at least a subset of at least one codeword of the plurality of codewords comprises multiplying data symbols from two or more codewords of the plurality of codewords by a unitary matrix.

20. The media of claim 16, wherein spreading each data symbol of the at least a subset of at least one codeword of the plurality of codewords comprises multiplying data symbols from two or more codewords of the plurality of codewords by a discrete Fourier transform matrix or an inverse discrete Fourier transform matrix.
